(19) United States
(12) Patent Application Publication
(10) Pub. No.: US 2026/0340416 A1
(43) Pub. Date: Oct. 29, 2026

(54) METHOD FOR GENERATING TRAINED MODEL

(71) Applicant: TOYOTA JIDOSHA KABUSHIKI KAISHA, Aichi-ken (JP)

(72) Inventors: Jingjing PAN, Shinjuku-ku (JP); Quan KONG, Toshima-ku (JP); Norimasa KOBORI, Nakano-ku (JP)

(21) Appl. No.: 19/647,895

(22) Filed: Apr. 15, 2026

(30) Foreign Application Priority Data
Apr. 25, 2025 (JP) 2025-073560

(51) Int. Cl. G06N 3/096

(52) U.S. Cl. CPC G06N 3/096

(57) ABSTRACT

A method for generating a trained model according to the present disclosure acquires input information, acquires output information, and trains a learning model using multiple sets of the input information and the output information as training data. The input information includes a video, first region information indicating a first region that is a region of at least one instance contained in a first frame of the video, and a prompt instructing the output of a description of the instance contained in the first region. The output information includes a description of the at least one instance and second region information indicating a second region in a time-series, obtained by tracking the first region in each of multiple frames included in the video.

### CROSS-REFERENCE TO RELATED APPLICATION

This application claims priority to Japanese Patent Application No. 2025-073560, filed on Apr. 25, 2025, the entire contents of which are incorporated herein by reference.

### TECHNICAL FIELD

The present disclosure relates to a method for generating a trained model.

### BACKGROUND

The development of vision large language models (VLLMs) is in progress as multimodal machine learning models capable of handling text information and image information including videos. For example, Patent Literature (PTL) 1 proposes a machine learning model that takes, as input, a video and an instruction sentence regarding a stop position of a mobile object within the video, and outputs a stop position corresponding to the instruction sentence in the video.

### CITATION LIST

Patent Literature

PTL 1: JP 2024-031978 A

### SUMMARY

Conventional VLLMs have learned from videos as a whole without paying special attention to spatial and temporal changes of individual instances contained in the videos. Therefore, there is room to improve the accuracy of generating descriptions for each instance in the videos and answering questions about each instance.

It would be helpful to improve the performance of grasping temporal and spatial changes of instances contained in a video in a multimodal machine learning model that handles videos and text.

A method for generating a trained model according to an embodiment of the present disclosure includes:
acquiring input information that includes a video, first region information indicating a first region that is a region of at least one instance contained in a first frame of the video, and a prompt instructing the output of a description of the instance contained in the first region;
acquiring output information that includes a description of the at least one instance and second region information indicating a second region in a time series, obtained by tracking the first region in each of multiple frames included in the video; and
training a learning model using multiple sets of the input information and the output information as training data.

According to the present disclosure, it is possible to improve the performance of grasping temporal and spatial changes of instances contained in a video in a multimodal learning model that handles videos and text.

### BRIEF DESCRIPTION OF THE DRAWINGS

In the accompanying drawings:

FIG. 1 is a block diagram illustrating a schematic configuration of a learning apparatus according to an embodiment of the present disclosure;

FIG. 2 is a diagram explaining a learning model of FIG. 1; and

FIG. 3 is a flowchart illustrating a procedure for generating a trained model.

### DETAILED DESCRIPTION

### Configuration of Learning Apparatus

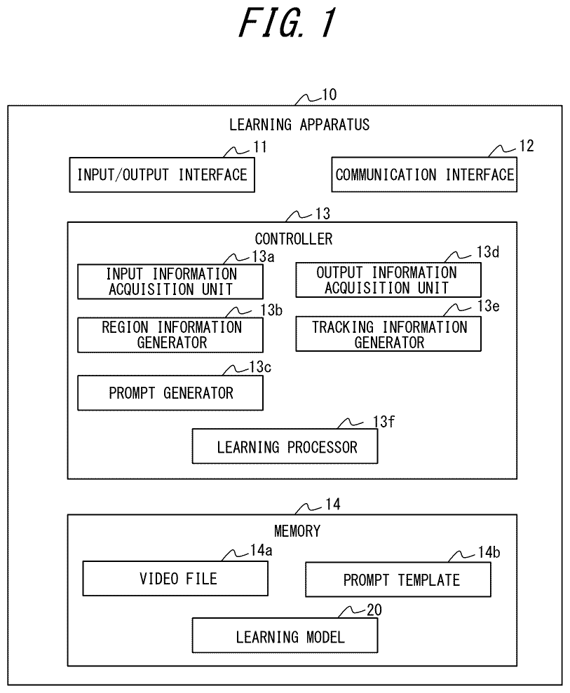

FIG. 1 is a diagram illustrating a schematic configuration of the learning apparatus 10 according to an embodiment. The learning apparatus 10 is a device that generates a trained model that improves the performance of grasping temporal and spatial changes of instances contained in a video by training a multimodal learning model 20. In the present disclosure, an instance refers to a specific object, person, or animal. The learning apparatus 10 is, for example, a computer such as a server apparatus. The learning apparatus 10 may be a general-purpose computer or a dedicated computer specialized for the functions of the learning apparatus 10. The learning apparatus 10 may be a server apparatus belonging to a cloud computing system. As shown in FIG. 1, the learning apparatus 10 includes an input/output interface 11, a communication interface 12, a controller 13, and a memory 14. The memory 14 includes the learning model 20, which is the subject of machine learning for the learning apparatus 10.

The input/output interface 11 includes devices such as a keyboard, mouse, and display for inputting and outputting information between the user operating the learning apparatus 10, as well as means for transferring data between devices connected to the learning apparatus 10. The communication interface 12 is an interface for transmitting and receiving information with other information processing apparatuses.

The controller 13 includes at least one processor, at least one dedicated circuit, or a combination thereof. The processor is a general purpose processor, such as a central processing unit (CPU) or a graphics processing unit (GPU), or a dedicated processor dedicated to specific processing. The controller 13 executes processes related to the operations of the learning apparatus 10 while controlling its components. The controller 13 may include functional blocks such as an input information acquisition unit 13a, a region information generator 13b, a prompt generator 13c, an output information acquisition unit 13d, a tracking information generator 13e, and a learning processor 13f. Each functional block of the controller 13 may be a hardware module or a software module.

The input information acquisition unit 13a acquires input information for additional training of the learning model 20. The input information includes a video, first region information indicating a first region that is a region of at least one instance contained in the first frame of the video, and a prompt instructing the output of a description of the instance contained in the first region. In this application, additional training means performing learning to adapt a pre-trained learning model to a specific task, that is, supervised fine-tuning (SFT). The video may be a video created for additional training of the learning model 20. The video may be a dataset of publicly available videos for machine learning. The first frame is one of multiple frames contained in each scene of the video. The first frame may be the temporally first frame included in a sequence of scenes of the video. The input information acquisition unit 13a may acquire input information from the outside via the input/output interface 11 or the communication interface 12. Alternatively, the input information acquisition unit 13a may acquire input information stored in advance in the memory unit 14 from the memory unit 14. In addition, the input information acquisition unit 13a may acquire input information generated by the region information generator 13b and/or the prompt generator 13c as follows.

The region information generator 13b generates first region information of the first frame from the video. The first region information is expressed, for example, as the coordinates of bounding boxes surrounding one or more instances in the video. The region information generator 13b passes the generated first region information to the input information acquisition unit 13a. The region information generator 13b is not a mandatory component.

The prompt generator 13c generates a prompt that instructs to generate and output a detailed description of a specific area of the specified video based on the input information of the video, the first region information, and the prompt template 14b stored in the memory unit 14. An example of the generated prompt is as follows. “The video <video location information> provides an overview of the video. Please provide a detailed description of the area indicated by <information specifying the first region>.”

Here, “video location information” indicates where the video is stored. “Information specifying the first region” includes information such as the coordinates of the first region. The basic content of the prompt sentence is fixed, and the parts <video location information> and <information specifying the first region> are changed according to the input information. The prompt generator 13c passes the generated prompt to the input information acquisition unit 13a. The prompt generator 13c is not a mandatory component.

The output information acquisition unit 13d acquires the output information that should be output when input information is input to the learning model 20. The output information includes the description of the instance specified by the first region information contained in the input information, and the second region information indicating the second region obtained by tracking the first region in each of the multiple frames contained in the video in a time series. The second region information may include the coordinates of the bounding boxes of each frame obtained by tracking the bounding box surrounding the instance specified by the first region information. The output information acquisition unit 13d may acquire the output information from the outside via the input/output interface 11 or the communication interface 12. Alternatively, the output information acquisition unit 13d may acquire output information stored in advance in the memory 14 from the memory 14. Also, the output information acquisition unit 13d may acquire output information generated by the tracking information generator 13e as described below.

The tracking information generator 13e tracks the movement of instances surrounded by the first region of the first frame of the video for each frame of the video. For object detection in the video, object detection models such as YOLO (You Only Look Once) or Faster R-CNN (Faster Region-based CNN) can be used. Additionally, methods such as the Kalman filter method and/or optical flow method can be used for object tracking. The tracking information generator 13e passes the generated second region information to the output information acquisition unit 13d.

The controller 13 may acquire a pre-prepared description of the instance from an external device via the communication interface 12 or from the memory 14. Furthermore, the controller 13 may have the function of generating a description of the instance contained in the video based on the video. The description of the instance may be generated by the user to be of desirable content. Alternatively, the description of the instance may be one that has been semi-automatically generated and modified by the user to be of desirable content.

The learning processor 13f performs additional training on the learning model 20 to generate the desired trained model. The learning processor 13f expands the learning model stored in the memory 14 in memory and provides multiple sets of input information and output information as training data to train the learning model.

The memory 14 includes at least one semiconductor memory, at least one magnetic memory, at least one optical memory, or a combination of at least two of these. The memory 14 stores programs and data used for the operations of the learning apparatus 10 and data obtained by the operations of the learning apparatus 10. The memory 14 may store, in addition to the learning model 20 subject to additional training, a video file 14a that stores video and a prompt template 14b, etc.

The functions of the learning apparatus 10 are realized by executing a program related to the method of generating the trained model of the present embodiment by a processor corresponding to the controller 13. That is, the functions of the learning apparatus 10 are realized by software. The program can be recorded on a computer readable recording medium.

### Learning Model

Next, an example of the learning model 20 will be described. The learning model 20 includes a large language model 21 (LLM: Large Language Model), a text information tokenizer 22, a video encoder 23, a visual information tokenization converter 24, and a region information encoder 25. The learning model 20 inputs input information including prompts, video, and first region information 33 to estimate the description of the instance corresponding to the first region information 33 and output information including second region information. The learning apparatus 10 performs additional training of the learning model 20 so that the learning model 20 generates output information accurately from input information.

The large language model 21 is a pre-trained natural language processing AI (Artificial Intelligence) that has learned from a large amount of text data. The large language model 21 includes models such as GPT (Generative Pre-trained Transformer) and BERT (Bidirectional Encoder Representations from Transformers). The text information tokenizer 22 divides the prompt into units (for example, words, punctuation, symbols, or parts of words) that can be processed by the large language model 21 (tokenization). The large language model 21 converts the text into numerical tokens through tokenization and inputs them into the large language model 21. The video encoder 23 extracts temporal and spatial features from the video and converts them into numbers (vectors). The video encoder 23 can be generated by performing pre-training using a large dataset in advance. The video encoder 23 can use a learning model that can integratively process different types of information, such as UMT (Unified Multi-modal Transformers).

The visual information tokenization converter 24 converts the feature quantities output by the video encoder 23 into a token sequence that can be processed by the large language model 21. The visual information tokenization converter 24 inputs the token sequence into the large language model 21. The visual information tokenization converter 24 can perform learning using machine learning. The visual information tokenization converter 24 includes, for example, a multilayer perceptron (MLP) or Q-Former. The visual information tokenization converter 24 operates as an alignment mechanism to align the video features extracted by the video encoder 23 with the text features generated by the large language model 21. The visual information tokenization converter 24 receives the feature quantities extracted from the video encoder 23 as input and can learn the relevance to the text feature quantities. If the visual information tokenization converter 24 includes Q-Former, the prompt tokenized by the text information tokenizer 22 may be input to the visual information tokenization converter 24. The visual information tokenization converter 24 combines the token sequence obtained by tokenizing the video with the tokens of the prompt and inputs them into the large language model 21.

The region information encoder 25 acquires the first region information 33 and encodes and tokenizes it. As a result, the first region information 33 is represented as a multidimensional vector, for example, 256 dimensions, 512 dimensions, or 1024 dimensions. The region information encoder 25 inputs the tokenized first region information 33 into the large language model 21. The region information encoder 25 includes a function approximator that can learn the relationship between inputs and outputs, such as a multilayer perceptron (MLP). The tokenized first region information may be embedded as information specifying the first region in the tokenized prompt input to the large language model 21 from the visual information tokenization converter 24.

The large language model 21 receives encoded and/or tokenized input information output from the text information tokenizer 22, visual information tokenization converter 24, and region information encoder 25, and generates output information. In order to output the second region information, the prompt generated by the prompt generator 13c may include instructions to output the second region information. Alternatively, another mechanism may be provided for the learning model 20 to output the second region information from the large language model 21.

### Generation of the Trained Model

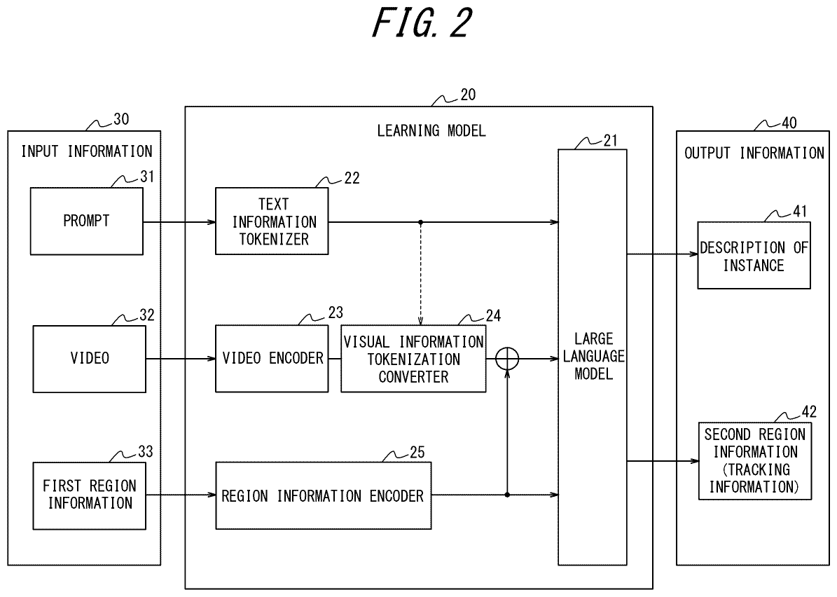

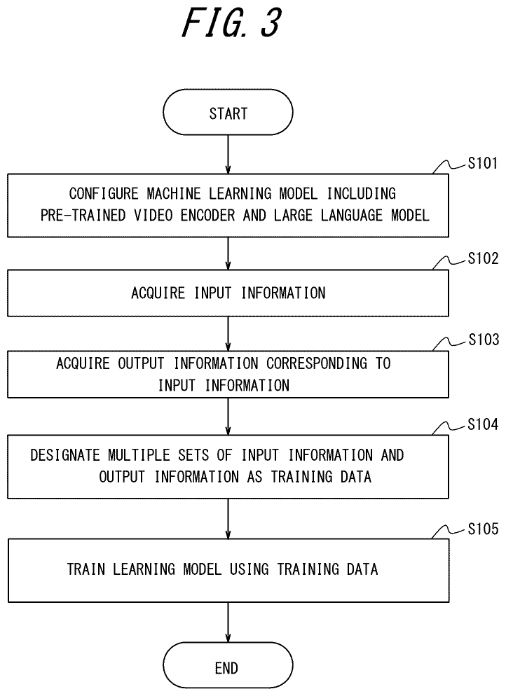

Below, the procedure for performing additional training on the learning model 20 using the controller 13 of the learning apparatus 10 to generate a trained model will be explained with reference to FIG. 3. First, the learning model 20 shown in FIG. 2 is constructed using the pre-trained large language model 21 and the video encoder 23 that has been pre-trained with a large amount of video data (S101). The controller 13 acquires multiple sets of input information for machine learning consisting of prompts, videos, and first region information 33 (S102). The controller 13 acquires multiple sets of output information for machine learning corresponding to the input information consisting of the description of the instance and the second region information (S103). The controller 13 uses the multiple sets of input information acquired in S102 and the output information acquired in S103 as training data (S104).

Next, the controller 13 trains the learning model 20 using the training data (S105). The training is performed as additional training on the learning model 20 that has been partially pre-trained. The controller 13 adjusts the model parameters to minimize the error (loss) between the output information (estimation result) of the learning model 20 and the output information of the training data. That is, the parameters of the learning model 20 are adjusted to minimize the error of the description of the instance predicted from the prompt and the error of the position of the bounding box included in the second region information.

The learning model 20 can perform learning in stages. For example, in the first stage, the controller 13 performs learning of the visual information tokenization converter 24 while keeping the parameters of the large language model 21 and video encoder 23 fixed (frozen). In the second stage, the controller 13 can update some of the parameters of the large language model 21 and video encoder 23 in addition to the parameters of the visual information tokenization converter 24. In the third stage, at least some of the parameters of the region information encoder 25 are made updatable to perform tuning of the entire learning model 20. The controller 13 generates the trained model by the processing from S101 to S105, or by performing further training in addition to the processing from S101 to S105.

According to the present disclosure, the input information includes a prompt that outputs a description of the instance in the video and the first region information 33 of the instance in the first frame. In addition, the output information includes a description of the instance and second region information that tracks the instance's area. Furthermore, the learning model 20 includes a region information encoder 25 that encodes the first region information 33. As a result, the trained model generated by additional training becomes easier to learn the spatial and temporal changes of instances in the video. Consequently, the trained model becomes easier to grasp instances whose position and size change within the video. Additionally, the trained model can provide a foundation for generating descriptions of instances with higher accuracy. The trained model generated by the present disclosure is trained to follow user-specific instructions regarding instances by further tuning after performing additional training related to the present disclosure. This allows users of the trained model to give various instructions regarding instances contained in the video, not limited to the output of the description of the instance.

It should be noted that the present disclosure is not limited to the above embodiment, and various modifications and revisions can be implemented. For example, functions or the like included in each means, each step, or the like can be rearranged without logical inconsistency, and a plurality of means, steps, or the like can be combined into one or divided.

1. A method for generating a trained model comprising:
acquiring input information that includes a video, first region information indicating a first region that is a region of at least one instance contained in a first frame of the video, and a prompt instructing output of a description of the instance contained in the first region;
acquiring output information that includes a description of the at least one instance and second region information indicating a second region in a time series, obtained by tracking the first region in each of multiple frames included in the video; and
training a learning model using multiple sets of the input information and the output information as training data.

2. The method according to claim 1, comprising training the learning model as additional training for the learning model generated by pre-training, the learning model handling at least text and videos.

3. The method according to claim 2, wherein
the learning model includes a pre-trained large language model, and
the first region information is tokenized by a region information encoder and input to the pre-trained large language model.

4. The method according to claim 3, wherein the region information encoder includes a function approximator that is capable of learning relationship between input and output.

5. The method according to claim 3, wherein the learning model is configured such that the first region information tokenized by the region information encoder is embedded as information indicating the first region in the prompt.
